(19) United States
(12) Patent Application Publication
(10) Pub. No.: US 2016/0040868 A1
(43) Pub. Date: Feb. 11, 2016

(54) ILLUMINATED HAIR BAND

(71) Applicant: DEBORAH A. LAWSON, AUDUBON, NJ (US)

(72) Inventor: DEBORAH A. LAWSON, AUDUBON, NJ (US)

(21) Appl. No.: 14/819,877

(22) Filed: Aug. 6, 2015

Related U.S. Application Data
(60) Provisional application No. 62/034,403, filed on Aug. 7, 2014.

(51) Int. Cl. F21V 33/00; F21V 11/16; A45D 8/36; F21V 9/00

(52) U.S. Cl. CPC F21V 33/0008; F21V 9/00; F21V 11/16; A45D 8/36; F21Y 2101/02

(57) ABSTRACT

A lighted headband includes an upper plate and side temples pivotally attached thereto. The plate is made of a transparent or translucent material capable of functioning as a wave guide for visible light. A plurality of indentations is formed in the upper surface of said plate and extend partially through the thickness of said plate. The bottom surface of the plate includes recesses for holding a plurality of LED's. The upper surface of the plate and the side walls of the indentations are covered with an opaque material that prevents light from passing through the upper surface of the plate except in the areas of the indentations.

### CROSS REFERENCE TO RELATED APPLICATION

This application claims the benefit of Provisional Patent Application No. 62/034,403, filed Aug. 7, 2014.

### BACKGROUND OF THE INVENTION

The present invention is directed toward an illuminated hair band or headband and more particularly toward a foldable hair band that includes a pleasing soft lighted display. It is an improvement on Applicant's prior U.S. Pat. No. 7,156,106, the entire disclosure thereof is incorporated herein by reference.

In the improved hair band of the invention, there is included a power source which is preferably a rechargeable battery. The illumination is provided by specially positioned LED's within the hair band housing and can include a personalized display such as a person's name.

Lighted hair bands, barrettes and the like have been known for some time. For example, U.S. Pat. No. 7,731,378 to Dutcher shows a barrette with a plurality of LED lights and a control circuit that allows the lights to blink in unison or in sequence or in a wide variety of other patterns. There is no suggestion, however, that the system be used on a folding hair band as with the present invention.

Published International Application No. WO 2013/074799 to Tjalsma is directed toward a wearable band with LED lights that can be used to display indicia such as the word LOVE. There is no suggestion, however, that the invention shown therein could be incorporated into a headband or hair band. The published International Application No. WO 2006/092598 to Khanzada does suggest that LED's can be incorporated directly into a hair band but the manner in which the lights are displayed is not clear and there is no suggestion that the hair band be foldable.

LED's are, of course, the preferred light source for hair bands and similar articles for several reasons. These include their high operating life, small form factor, high output, diverse selection of color, operating options (continuous/ intermittent, intensity fade change, etc.), extraordinarily high availability of both core components and driving hardware, and relatively low cost. No other illumination source can compare to LED's when subjected to comparison across all of the required technical fields. LED's are ubiquitous devices found in almost every industry for the exact reasons stated above. However, LED's suffer from several shortcomings.

One of the best attributes of an LED is its ability to provide high output illumination from an extremely small form and power consumption factor. While this is a positive effect for most applications, it is a negative effect when incorporating into a product designed to be elegant, sophisticated, and polished such as a hair band.

FIG. 1 is a representation of the prior art wherein the LED is a point source illumination device. In most systems, including every patented system found that involves LED's as an illumination source for hair accessories, illumination sources are placed to maximize output. However, this placement method creates an uncontrolled point source effect. A “point source” or “pinpoint” light source is defined as any light source that, from a sufficient distance can be thought of as a point in space.

This effect is both aesthetically unpleasant and, in cases where the output of the LED is sufficiently high, leads to potential eye strain. Additionally, given the requirements of the inventive hair band system, the combination of the individual functional and cosmetic elements comprising the total part must be seamlessly integrated to produce the effect of a single element to the user. In other words, the light needs to be appear to be a part of the entire product without the appearance of a source (point or otherwise).

All known patented systems simply utilize the base structure of a device as a mechanical “holder” for the illumination source. The observed effect to the user is simply a combination of “light elements” held in place by a mechanical structure. None of these is suitable for the present design as they do not provide the desired appearance.

### SUMMARY OF THE INVENTION

By exploiting engineering knowledge usually reserved for optical communication systems, the present invention utilizes a novel approach to provide illuminated accessories that not only removes the detrimental pinpoint light effects discussed above, but is able to manipulate the output of multiple LED's such that the customer observes a design that seemingly produces light throughout the entire product with no real point of origin. The overall effect is a product that delivers a feeling of luminescence.

The foregoing is achieved through the calculated orientation and placement of the LED light sources, judicious use of materials consisting of different transmissive, reflective, and absorptive (herein referred to simply as optical) properties, and further manipulating those materials to change their optical surface properties as will be explained below.

### BRIEF DESCRIPTION OF THE DRAWINGS

For the purpose of illustrating the invention, there is shown in the accompanying drawings one form which is presently preferred; it being understood that the invention is not intended to be limited to the precise arrangements and instrumentalities shown.

FIG. 1 is a schematic representation of manner in which LED's are utilized in the prior art;

FIG. 2 is a view similar to FIG. 1 showing a first arrangement according to the invention;

FIG. 3 is a view similar to FIG. 1 showing a second arrangement according to the invention;

FIG. 4 is a view similar to FIG. 1 showing a third arrangement according to the invention;

FIG. 5 is a view similar to FIG. 1 showing a fourth arrangement according to the invention;

FIG. 6 is a view similar to FIG. 1 showing a fifth arrangement according to the invention;

FIG. 7 represents a simple application of the invention as specifically applied to a hair band, and

FIG. 8 is a sectional view of a portion of FIG. 7 showing some of the details thereof.

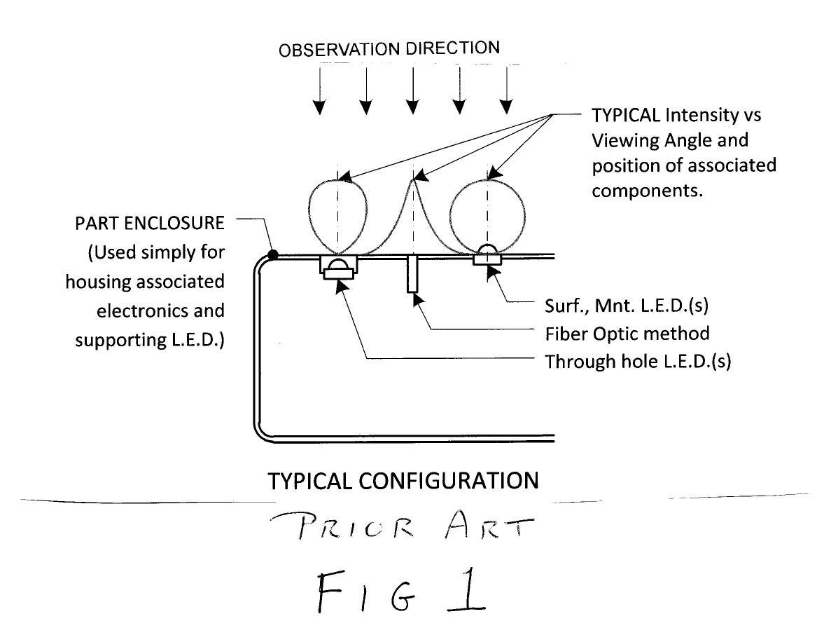

### DETAILED DESCRIPTION OF THE PREFERRED EMBODIMENTS

One inventive aspect of the invention is to integrate the material used to normally mechanically hold LED's in a fixed position as part of a light delivery system to minimize and or otherwise direct the pinpoint light emissions caused by any pin point light source away from an observer.

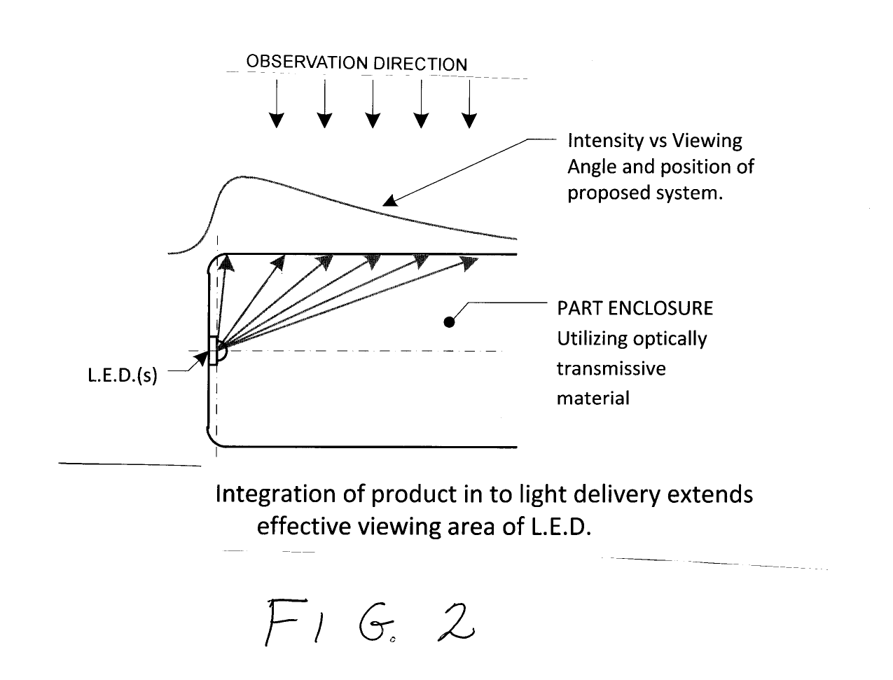

As can be seen in FIG. 2, by placing and/or embedding the LED's into a material of sufficient optical transmissivity (such as acrylic, glass, etc.), of uniform index of refraction, and sufficient clarity (defined here as containing a minimum of imperfections within the material), delivered light will travel through the material unobserved by the user until it reaches a surface interface of different index of refraction. This allows one to be able to facilitate the use of the product as part of an integrated light delivery system. Furthermore, when combined with the following features, this will also facilitate the reduction/removal of the pinpoint effect of LED's.

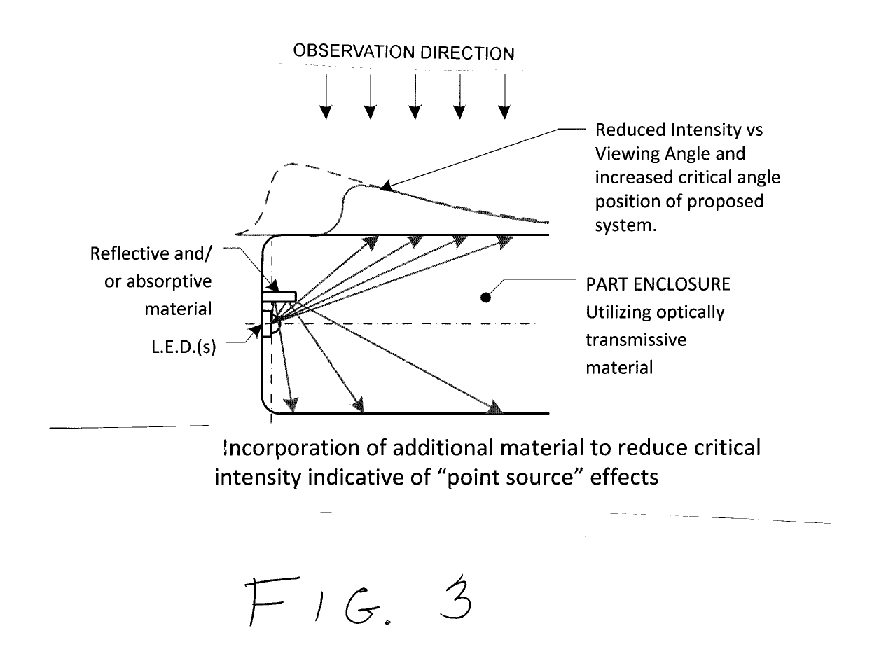

A second aspect of the invention concerns utilizing additional material containing different optical properties to minimize pinpoint light emission. As shown in FIG. 3, by incorporating additional materials either of high optical absorption or reflection, into the product (and located along the optical path between observer and light source) the pinpoint effect of the light source and can greatly be minimized and or removed from the observer completely.

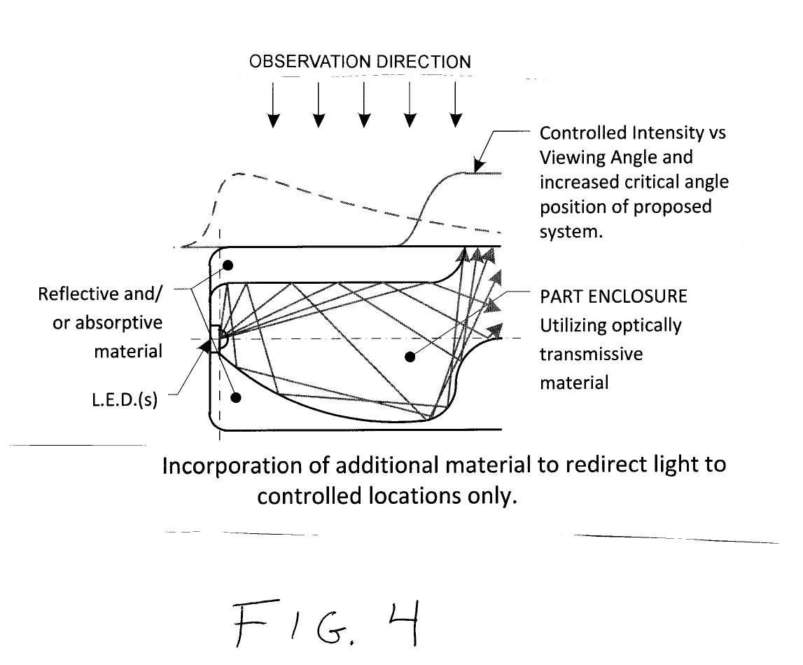

Additionally, and as shown in FIG. 4, by integrating multiple material types in to the product, emitted light can also be manipulated in such ways so as to provide a user a multitude of optical effects that appear to be self-illuminated (i.e., no light source is evidenced by the observer).

In the arrangement shown in FIG. 4, the invention essentially utilizes Snells Law and Brewster's angle criteria in conjunction with materials encasing the optical path to create the “light pipe” effect. Exception being that the path is also a design element of the product and not just a transmission method.

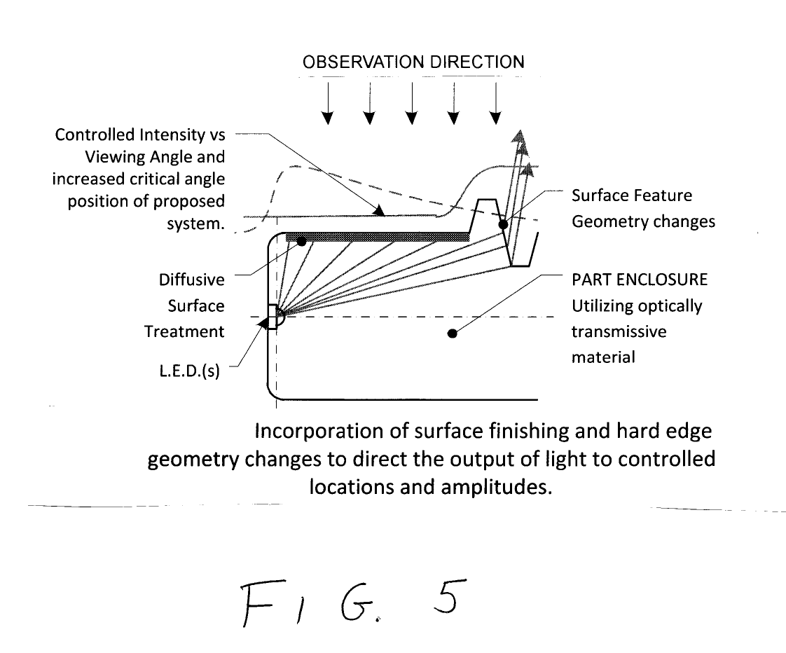

By changing the surface finish of selected material on the product, the optical clarity, and hence transmissivity can be altered to provide light to the observer in a controlled manner. As shown in FIG. 5, surface finishing can be changed simply via any number of various secondary processes, such as surface roughing through mechanical, chemical, and/or laser etching to create a diffusive surface thereby lowering the output amplitude of the delivered light across a uniform plane. Surface polishing acts to increase the output amplitude of the delivered light, while changing the geometry of the observable plane can direct light to the user in predefined patterns.

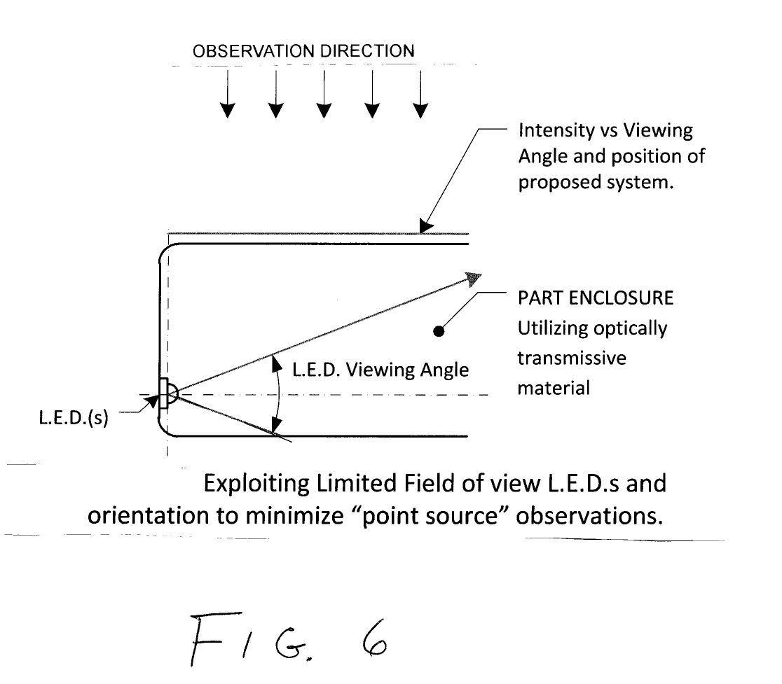

Finally, the light sources can be oriented in such a way so as to minimize the pinpoint effect when viewed by an observer. This can be achieved using both omnidirectional and/or light sources that have a limited viewing angle. As shown in FIG. 6, by orienting the light sources in a material that is optically transmissive and of sufficient quality, the light travels throughout the material without the source being observed by the user. In short, the LED's can be oriented in such a way that their viewing angles are not visible to the observer.

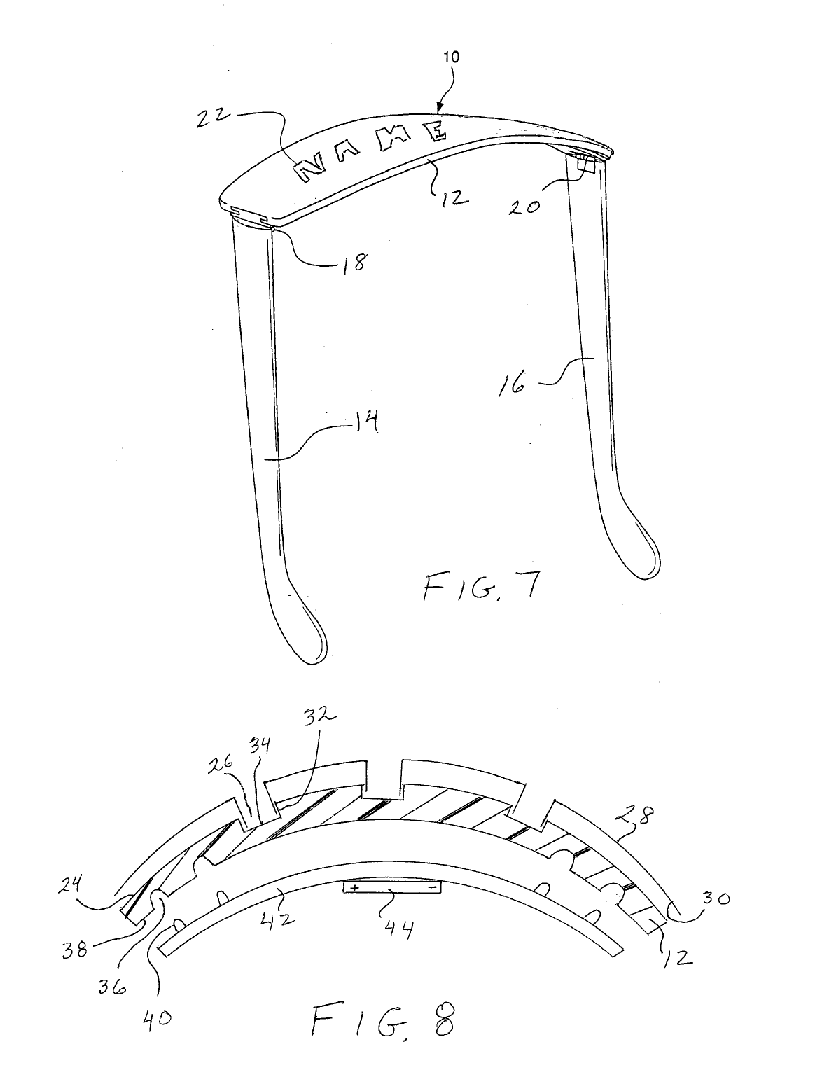

One relatively simple and practical application of the invention is shown in FIGS. 7 and 8. The headband 10 shown in FIG. 7 is constructed in a manner very similar to that shown in my prior U.S. Pat. No. 7,156,106. It includes an upper decorative plate 12 and a pair of temple earpieces 14 and 16 that are hinged to the plate 12 through the hinges 18 and 20.

The upper surface of the plate 12 includes a name or logo or the like 22 which is the portion of the headband 10 intended to be illuminated. Preferably, the upper plate 12 is comprised of a transparent or translucent plastic or glass material which is capable of functioning as a wave guide for light rays as more fully described above.

As shown most clearly in FIG. 8, the name or logo is formed by etching or carving out the same from the very top surface 24 of the plate 12 to form indentations such as shown at 26 in the upper surface. In order to provide sharp lines and avoid jagged edges and the like, the etching is preferably formed by a laser. As can be seen, the etching passes only partially through the material forming the plate 12 and does not pass all the way through the same.

The uppermost surface 24 of the plate 12 is covered with an opaque material 28 which may have a reflective undersurface 30. The material 28 also covers the side walls 32 of the etchings 26 but not the bottom most walls 34 thereof.

A plurality of recesses 36 are formed in the bottom wall 38 of the plate 12. A plurality of LED's 40 carried by a support 42 is intended to be inserted into the openings or recesses 36. The support 42 also supports a portable electrical supply such as a rechargeable battery 44. Appropriate circuitry and switches, not shown, are also included.

When the hair band 10 is assembled, the LED's 40 are inserted into the recesses or openings 36. When they are turned on, the interior of the plate 12 becomes illuminated. However, because the upper surface 24 of the plate 12 is covered by the opaque material 28, the light does not pass through the majority of the top of the hair band. Rather, the light is guided through the main body of the plate 12 to the etched portions forming the logo 22 where the light does pass upwardly through the plate 12.

Furthermore, because the side walls of the etchings 26 are also covered with the opening material, the light is forced pass only upwardly and is not diffused significantly. With relatively small LED's and very little power, this provides a very significant and bright lighted logo which can be clearly seen and distinguished from considerable distances and which does not have the deficiencies of the prior art pinpoint LED lights described above.

From the foregoing description, one skilled in the art can easily ascertain the essential characteristics of this invention and, without departing from the spirit and scope thereof, can make various changes and modifications of the invention to adapt it to various usages and conditions. It is to be understood that the present invention is not limited to the embodiments described above, but encompasses any and all embodiments within the scope of the following claims.

I claim:

1. A lighted headband including:
an upper plate, said plate being made of a transparent or translucent material capable of functioning as a wave guide for visible light, said plate having an upper surface and a lower surface and a thickness therebetween;
a plurality of indentations formed in said upper surface of said plate and extending partially through the thickness of said plate, said indentations having lower walls and side walls;
at least one LED light source located below the upper surface of said upper plate, and
means for directing light from said light source upwardly only through said lower walls of said indentations.

2. The lighted headband as claimed in claim 1 wherein said light source is comprised of a plurality of LED's.

3. The lighted headband as claimed in claim 2 further including a plurality of recesses formed in said lower surface of said plate and wherein said LED's are located within said recesses.

4. The lighted headband as claimed in claim 3 wherein opaque material prevents light from passing through said upper surface of said plate except in the areas of said indentations.

5. The lighted headband as claimed in claim 4 wherein opaque material prevents light from passing through said side walls of said indentations.

6. The lighted headband as claimed in claim 1 wherein said headband includes temples pivotally attached to said plate so that said headband can be folded.
